(19) United States
(12) Patent Application Publication
(10) Pub. No.: US 2015/0087803 A1
(43) Pub. Date: Mar. 26, 2015

(54) Process for preparing poly(N-acylamides) and poly(N-acylamides) as obtained

(71) Applicant: RHODIA OPERATIONS, Aubervilliers (FR)

(72) Inventors: Roland Jacquot, Francheville (FR); Philippe Marion, Vernaison (FR); Franck Touraud, Le Chamboud (FR)

(21) Appl. No.: 14/387,648

(22) PCT Filed: Mar. 19, 2013
(86) PCT No.: PCT/EP2013/055667

§ 371 Date: Sep. 24, 2014

(30) Foreign Application Priority Data
Mar. 28, 2012 (FR) 1252790

(51) Int. Cl. C08G 69/00

(52) U.S. Cl. CPC C08G 69/00
USPC 528/363

(57) ABSTRACT

The present invention relates to a process for preparing a poly(N-acylamide) by reaction between: —at least one compound of the following formula (I): X—R₁—Y (I) and —at least one compound of the following formula (II): X′—R₂—Y′ (II) in which: —R₁ and R₂ are, independently of one another, chosen from the group consisting of: a linear or branched alkylene group, comprising from 4 to 20 carbon atoms, an arylene group comprising from 5 to 30 carbon atoms, a heteroarylene group comprising from 5 to 30 atoms, a cycloalkylene group comprising from 5 to 30 carbon atoms, an arylalkylene group comprising from 5 to 30 carbon atoms.

The present invention relates to a process for preparing poly(N-acylamides).

The present invention also relates to the poly(N-acylamides) thus obtained, and also to the uses thereof.

Various processes exist in the literature for preparing poly(N-acylamides), especially from diacids and N-acylisocyanates. However, these processes often involve the generation of side products. Moreover, such processes are not easy to perform.

There is thus a need to develop a novel process for preparing poly(N-acylamides) which does not have the drawbacks mentioned above.

One of the aims of the present invention is to provide a process for preparing poly(N-acylamides) that is easy to perform.

Another aim of the present invention is to provide a process for preparing poly(N-acylamides) that allows the use of a variety of monomers.

The present invention is also aimed at providing a preparation process that does not generate any side products.

Another aim of the present invention is to provide novel poly(N-acylamides).

The subject of the present invention is thus a process for preparing a poly(N-acylamide) by reaction between:
at least one compound of formula (I) below:

X—R₁—Y (I)

and
at least one compound of formula (II) below:

X′—R₂—Y′ (II)

in which:

R₁ and R₂ are, independently of each other, chosen from the group consisting of:
a linear or branched alkylene group comprising from 4 to 20 carbon atoms, optionally comprising heteroatoms, said alkylene group optionally being substituted;
an arylene group, comprising from 5 to 30 carbon atoms, said arylene group optionally being substituted;
a heteroarylene group comprising from 5 to 30 atoms, said heteroarylene group optionally being substituted;
a cycloalkylene group comprising from 5 to 30 carbon atoms, said cycloalkylene group optionally being substituted;
an arylalkylene group comprising from 6 to 30 carbon atoms, said arylalkylene group optionally being substituted;

X, X′, Y and Y′ represent, independently of each other, a CN or CO₂H function,

on condition that:
at least one from among X, X′, Y and Y′ represents a CN function;
at least one from among X, X′, Y and Y′ represents a CO₂H function;
when R₁ represents an arylene, heteroarylene or arylalkylene group, then X and Y are in the para or meta position relative to each other on, respectively, said arylene, heteroarylene or arylalkylene group, and
when R₂ represents an arylene, heteroarylene or arylalkylene group, then X′ and Y′ are in the para or meta position relative to each other on, respectively, said arylene, heteroarylene or arylalkylene group.

In the context of the invention, and unless otherwise mentioned, the term “poly(N-acylamide)” means a noncyclic polyimide, comprising at least one imide function.

According to the invention, the imide functions of the poly(N-acylamide) are those formed by reaction between the compounds of formulae (I) and (II). The poly(N-acylamide) prepared according to the invention thus has the repeating unit of the following formula: —[(C(═O)—NH—C(═O)—R₂—C(═O)—NH—C(═O)—R₁]—, with R₁ and R₂ as defined previously.

In the context of the invention, and unless otherwise mentioned, the condition “X and Y are in the para or meta position relative to each other on the arylalkylene group” means that X and Y are in the para or meta position on the aryl radical of the arylalkylene group.

In the context of the invention, and unless otherwise mentioned, the term “alkylene” means a divalent radical derived from a linear alkyl group lacking two hydrogen atoms, said alkyl group comprising from 4 to 20 carbon atoms. Mention may be made especially of butylene, pentylene and octylene.

In the context of the invention, and unless otherwise mentioned, the term “arylene” means a divalent radical derived from an aryl group lacking two hydrogen atoms, said aryl group being a monovalent monocyclic or polycyclic aromatic radical comprising from 5 to 30 carbon atoms. Mention may be made especially of phenylene, naphthylene and anthracylene.

In the context of the invention, and unless otherwise mentioned, the term “heteroarylene” means a divalent radical derived from a heteroaryl group lacking two hydrogen atoms, said heteroaryl group being a monovalent monocyclic or bicyclic aromatic radical comprising from 5 to 30 atoms, and especially from 1 to 5 heteroatoms chosen from nitrogen, oxygen and sulfur. Mention may be made especially of pyrrolylene, furanylene, thiophenylene and pyridinylene.

In the context of the invention, and unless otherwise mentioned, the term “arylalkylene” means an arylene-alkylene radical in which the arylene and alkylene groups are as defined above. Mention may be made especially of benzylene.

According to one embodiment, the present invention relates to a process for preparing a poly(N-acylamide) by reaction between:
at least one compound of formula (I) alone or a mixture of compounds of formula (I) as defined above, the groups R₁ being identical or different;
   and
at least one compound of formula (II) alone or a mixture of compounds of formula (II) as defined above, the groups R₂ being identical or different.

Thus, the process for preparing poly(N-acylamides) may consist of the reaction between:
at least one compound of formula (I) alone,
   and
at least one compound of formula (II) alone.

Thus, the process for preparing poly(N-acylamides) may also consist of the reaction between:
a mixture of compounds of formula (I) as defined above, the groups R₁ being identical or different;
   and
at least one compound of formula (II) alone.

The process for preparing poly(N-acylamides) may also consist of the reaction between:
at least one compound of formula (I) alone,
   and
a mixture of compounds of formula (II) as defined above, the groups R₂ being identical or different.

The process for preparing poly(N-acylamides) may also consist of the reaction between:
a mixture of compounds of formula (I) as defined above, the groups R₁ being identical or different;
   and
a mixture of compounds of formula (II) as defined above, the groups R₂ being identical or different.

According to one embodiment, in the compounds of formulae (I) and (II), X═X′, R₁═R₂ and Y═Y′. Thus, the process for preparing poly(N-acylamides) corresponds to the reaction between a compound of formula (I) identical to a compound of formula (II). This embodiment corresponds especially to the case where compounds (I) and (II) are mixed compounds, i.e. they bear both a CN function and a COOH function.

In the context of the invention, and unless otherwise mentioned, the term “mixed compound” means a compound of formula (I) (or (II)), for which one from among X and Y (X′ or Y′) represents a CN function and one from among X and Y (X′ or Y′) represents a COOH function. The compounds of formula (III′) as defined below may be mentioned, for example, as mixed compounds.

According to one embodiment, the process for preparing poly(N-acylamide) comprises the reaction between:
at least one compound of formula (I) as defined above,
at least one compound of formula (II) as defined above, and
at least one compound of formula (IV) below:

R—Z (IV)

in which R represents:
an optionally substituted linear or branched alkyl group comprising from 1 to 20 carbon atoms;
an optionally substituted aryl group comprising from 6 to 30 carbon atoms;
an optionally substituted heteroaryl group comprising from 5 to 30 atoms;
an optionally substituted arylalkyl group comprising from 6 to 30 carbon atoms; and Z represents COOH or CN.

Thus, the compounds of formula (IV) are monofunctional monomers, comprising a COOH or CN reactive function.

According to the invention, the use of compounds of formula (IV) may make it possible to block the formation of the main chain during the polymerization, insofar as the compounds of formula (IV) comprise only one reactive function, and/or optionally to provide different unreactive functions, in order to impart specific applicative properties (hydrophilicity, hydrophobicity, etc.).

According to another embodiment, the present invention relates to a process for preparing a poly(N-acylamide) by reacting:
at least one compound of formula (I′) below:

HOOC—R′₁—COOH (I′)

and
at least one compound of formula (II′) below:

NC—R′₂—CN (II′)

in which R′₁ and R′₂ satisfy, respectively, the definitions of R₁ and R₂ as mentioned above,

on condition that when R′₁ represents an arylene, heteroarylene or arylalkylene group, the two acid functions are in the para or meta position relative to each other on, respectively, said arylene, heteroarylene or arylalkylene group; and

on condition that when R′₂ represents an arylene, heteroarylene or arylalkylene group, the two nitrile functions are in the para or meta position relative to each other on, respectively, said arylene, heteroarylene or arylalkylene group.

According to the invention, the compounds of formula (I′) correspond to compounds of formula (I) in which X and Y represent COOH, or to compounds of formula (II) in which X′ and Y′ represent COOH.

According to the invention, the compounds of formula (II′) correspond to compounds of formula (I) in which X and Y represent CN, or to compounds of formula (II) in which X′ and Y′ represent CN.

According to another embodiment, the present invention relates to a process for preparing a poly(N-acylamide) by reacting:
at least one compound of formula (I′) alone or a mixture of compounds of formula (I′) as defined above, the groups R′₁ being identical or different;
   and
at least one compound of formula (II′) alone or a mixture of compounds of formula (II′) as defined above, the groups R′₂ being identical or different.

Thus, the process for preparing poly(N-acylamides) may consist of the reaction between:
at least one compound of formula (I′) alone,
   and
at least one compound of formula (II′) alone.

The process for preparing poly(N-acylamides) may also consist of the reaction between:
a mixture of compounds of formula (I′) as defined above, the groups R′₁ being identical or different;
   and
at least one compound of formula (II′) alone.

The process for preparing poly(N-acylamides) may also consist of the reaction between:
at least one compound of formula (I′) alone,
   and
a mixture of compounds of formula (II′) as defined above, the groups R′₂ being identical or different.

The process for preparing poly(N-acylamides) may also consist of the reaction between:
a mixture of compounds of formula (I′) as defined above, the groups R′₁ being identical or different;
   and
a mixture of compounds of formula (II′) as defined above, the groups R′₂ being identical or different.

According to another embodiment, the present invention relates to a process for preparing a poly(N-acylamide) by reaction between:
at least one compound of formula (III′) below:

NC—R′₃—COOH (III′)

and
at least one identical or different compound of formula (III′) as defined previously, or
at least one compound of formula (I′) as defined previously, or
at least one compound of formula (II′) as defined previously,

R′₃ being chosen from the group consisting of:
a linear or branched alkylene group comprising from 4 to 20 carbon atoms, optionally comprising heteroatoms, said alkylene group optionally being substituted;
an optionally substituted arylene group comprising from 5 to 30 carbon atoms;
an optionally substituted heteroarylene group comprising from 5 to 30 atoms; and
an optionally substituted cycloalkylene group comprising from 5 to 30 carbon atoms;
an optionally substituted arylalkylene group comprising from 6 to 30 carbon atoms;
on condition that when R′₃ represents an arylene, heteroarylene or arylalkylene, the nitrile function and the acid function are in the meta or para position relative to each other on, respectively, said arylene, heteroarylene or arylalkylene.

According to the invention, the compounds of formula (III′) correspond to compounds of formula (I) in which X represents CN and Y represents COOH, or vice versa, or to compounds of formula (II) in which X′ represents CN and Y′ represents COOH, or vice versa.

According to one embodiment, the present invention relates to a process for preparing a poly(N-acylamide) by reaction between:
at least one compound of formula (III′) below:

NC—R′₃—COOH (III′)

and
at least one identical compound of formula (III′),

i.e. compounds (III′) for which R′₃ is identical.

This embodiment corresponds to the reaction of a compound of formula (III′) with itself.

According to one embodiment, the present invention relates to a process for preparing a poly(N-acylamide) by reaction between:
at least one compound of formula (III′) below:

NC—R′₃—COOH (III′)

and
at least one different compound of formula (III′), i.e. a compound (III′) for which R′₃ is different.

In the context of the invention, and unless otherwise mentioned, the compounds of formulae (I), (II), (IV), (I′), (II′) and (III′) are monomers for preparing poly(N-acylamides). They are also reagents that are used in the process of the invention.

According to another embodiment, the present invention relates to a process for preparing a poly(N-acylamide) by reaction between:
at least one compound of formula (III′) as defined previously, and
at least one compound of formula (I′) and at least one compound of formula (II′), as defined above.

In the context of the process according to the invention, a mixture of several carboxylic acids and/or several nitrile compounds may be used.

In the context of the invention, and unless otherwise mentioned, the term “nitrile compound” means a compound comprising a nitrile function CN.

In the context of the invention, and unless otherwise mentioned, the term “carboxylic acid” means a compound comprising an acid function COOH.

In the context of the process according to the invention, a mixture of several compounds of formula (I) (or (I′)), in which the groups R₁ (or R′₁) are of different nature, may be used.

In the context of the process according to the invention, a mixture of several compounds of formula (II) (or (II′)), in which the groups R₂ (or R′₂) are of different nature, may be used.

In the context of the process according to the invention, a mixture of several compounds of formula (III′), in which the groups R′₃ are of different nature, may be used.

In the context of the invention, and unless otherwise mentioned, the term “from x to y” means that the limits x and y are included. For example, “an integer from 4 to 20” means that the integer is greater than or equal to 4 and less than or equal to 20.

In the context of the invention, and unless otherwise mentioned, the term “poly(N-acylamide)” means a noncyclic polyimide, comprising at least one imide function.

In the context of the invention, the reaction for preparing poly(N-acylamide) is a polycondensation, especially between at least one compound of formula (I) (or of formula (I′)) and at least one compound of formula (II) (or of formula (II′)).

According to the invention, the groups R′₁, R′₂, R₁, R₂, R′₃ and R₁ independently of each other, may be substituted with at least one function that is unreactive in the process of the invention. In particular, the groups R₁, R₂, R′₁, R′₂, R′₃ and R may be substituted with at least one function chosen especially from alkyl comprising from 1 to 10 carbon atoms, sulfonate, sulfonamide, phosphonate, phosphate, ether, ester, tertiary amine, urea, carbamate, alkylene comprising from 1 to 10 carbon atoms, ketone and phenol.

In the context of the invention, and unless otherwise mentioned, the term “function that is unreactive” in the process of the invention means a function that cannot react with one of the CN or CO₂H functions of the starting compounds, especially of the compounds of formula (I), (II), (II′), (1′) or (III′).

According to the invention, the groups R₁ and R₂, independently of each other, may be substituted with at least one CN or CO₂H function. Thus, the process according to the invention may be performed in the presence of diacids or polyacids, and of dinitriles or polynitriles.

According to the invention, the compounds of formula (I′) may be polyacids, when R′₁ is substituted with at least one CO₂H function. In particular, when R′₁ is substituted with a CO₂H function, compound (I′) is a triacid.

According to the invention, the compounds of formula (II′) may be polynitriles, when R′₂ is substituted with at least one CN function. In particular, when R′₂ is substituted with a CN function, compound (I′) is a trinitrile.

According to the invention, the compounds of formula (III′) may be polyfunctional compounds, when R′₃ is substituted with at least one CN function and/or at least one COOH function. In particular, when R′₃ is substituted with a CN function, compound (III′) is a dinitrile comprising a COOH function. In particular, when R′₃ is substituted with a COOH function, compound (III′) is a diacid comprising a CN function.

According to one embodiment, R₁ (R′₁) represents a butylene group.

According to another embodiment, R₁ (R′₁) represents an octylene group.

According to one embodiment, R₂ (R′₂) represents a butylene group.

According to another embodiment, R₂ (R′₂) represents an octylene group.

According to one embodiment, R₁ (R′₁) represents an arylene group comprising from 5 to 30 carbon atoms, in particular a phenylene group.

According to one embodiment, R₁ (R′₁) represents an arylene group comprising from 5 to 30 carbon atoms, said arylene group being substituted with a CO₂H function. In particular, R₁ (R′₁) represents a phenylene substituted with a CO₂H function.

According to one embodiment, R₂ (R′₂) represents an arylene group comprising from 5 to 30 carbon atoms, in particular a phenylene group.

According to one embodiment, R′₃ represents a linear alkylene group comprising from 4 to 20 carbon atoms, and preferably, R′₃ is a butylene.

According to one embodiment, R′₃ represents an arylene group comprising from 5 to 30 carbon atoms, especially a phenylene.

The process according to the invention may lead to poly(N-acylamides) that are of aliphatic nature, of (hetero)aromatic nature or of both (hetero)aromatic and aliphatic nature, and especially in identical or different proportions.

In the context of the invention, and unless otherwise mentioned, the term “poly(N-acylamide of aliphatic nature” means a poly(N-acylamide) prepared from non(hetero)aromatic compounds, and especially from compounds bearing linear or branched alkylene groups, or cycloalkylene groups.

In the context of the invention, and unless otherwise mentioned, the term “poly(N-acylamide of (hetero)aromatic nature” means a poly(N-acylamide) prepared from aromatic or heteroaromatic compounds, i.e. from compounds not comprising aliphatic groups.

In the context of the invention, and unless otherwise mentioned, the term “(hetero)aromatic” covers a heteroarylene and an arylene.

The process according to the invention may lead to poly(N-acylamides) that may be of aliphatic nature, especially when, in the compounds of formulae (I) and (II), R₁ and R₂ represent alkylene groups.

The process according to the invention may lead to poly(N-acylamides) that may be of aliphatic nature, especially when, in the compounds of formula (I′), (II′) and/or (III′), R′₁, R′₂ and/or R′₃ represent alkylene groups.

The process according to the invention may lead to poly(N-acylamides) that may be of (hetero)aromatic nature, especially when, in the compounds of formulae (I) and (II), R₁ and R₂ represent (hetero)arylene groups.

The process according to the invention may lead to poly(N-acylamides) that may be of (hetero)aromatic nature, especially when, in the compounds of formula (I′), (II′) and/or (III′), R′₁, R′₂ and/or R′₃ represent (hetero)arylene groups.

The process according to the invention may lead to poly(N-acylamides) that may be of aliphatic and (hetero)aromatic nature. This is the case when, in the compounds of formulae (I) and (II), R₁ and R₂ are of different nature, i.e. when R₁ is of aliphatic nature and R₂ is of (hetero)aromatic nature, or vice versa. This is also the case when, in the compounds of formulae (I′) and (II′), R′₁ and R′₂ are of different nature, i.e. when R′₁ is of aliphatic nature and R′₂ is of (hetero)aromatic nature, or vice versa. Furthermore, this is also the case when a compound of formula (III′) in which R′₃ is of aliphatic nature is reacted with a different compound of formula (III′), in which R′₃ is of (hetero)aromatic nature.

The process according to the invention may lead to poly(N-acylamides) that may be of aliphatic and (hetero)aromatic nature, especially when, in the compounds of formulae (I) and (II), at least one from among R₁ and R₂ represents an arylalkylene group, or alternatively when, in the compounds of formula (I′), (II′) and/or (III′), at least one from among R′₁, R′₂ and R′₃ represents an arylalkylene group.

According to the invention, among the compounds of formula (I′), mention may be made of sebacic acid, adipic acid, terephthalic acid, benzene-1,3,5-tricarboxylic acid, pimelic acid, suberic acid, azelaic acid, dodecanedioic acid, 1,3-cyclohexanedicarboxylic acid, 1,2-phenylenediacetic acid, 1,3-phenylenediacetic acid, 1,2-cyclohexanediacetic acid, 1,3-cyclohexanediacetic acid, 4,4′-benzophenonedicarboxylic acid, 2,5-naphthalenedicarboxylic acid, 2,2,6,6-tetrakis(P-carboxyethyl)cyclohexanone, 3,5,3′,5′-biphenyltetracarboxylic acid, 1,3,5,7-naphthalenetetracarboxylic acid, 2,4,6-pyridinetricarboxylic acid, 3,5,3′,5′-bipyridinetetracarboxylic acid, 3,5,3′,5′-benzophenonetetracarboxylic acid and 1,3,6,8-acridinetetracarboxylic acid.

In particular, among the compounds of formula (I′), mention may be made of one of the following compounds:

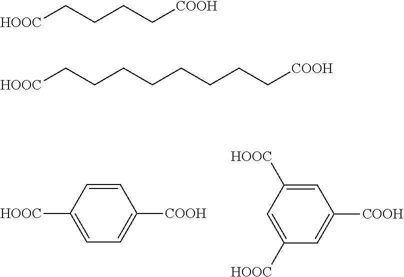 [SMILES: O=C(O)CCCCC(=O)O ; O=C(O)CCCCCCCCC(=O)O ; O=C(O)c1ccc(C(=O)O)cc1 ; O=C(O)c1cc(C(=O)O)cc(C(=O)O)c1]

According to the invention, among the compounds of formula (II′), mention may be made of adiponitrile, sebaconitrile and terephthalonitrile.

In particular, among the compounds of formula (II′), mention may be made of one of the following compounds:

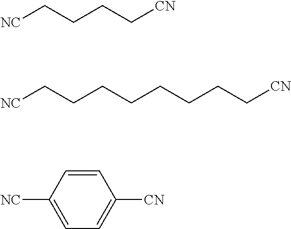 [SMILES: N#CCCCCC#N ; N#CCCCCCCCCC#N ; N#Cc1ccc(C#N)cc1]

According to the invention, among the compounds of formula (III′), mention may be made of 5-cyanovaleric acid and 4-cyanobenzoic acid.

In particular, among the compounds of formula (III′), mention may be made of one of the following compounds:

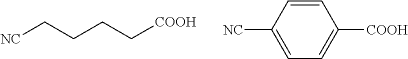 [SMILES: N#CCCCCC(=O)O ; N#Cc1ccc(C(=O)O)cc1]

According to one embodiment, the reaction is performed in the presence of compounds of formulae (I′) and (II′) below:

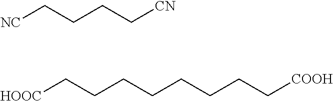 [SMILES: N#CCCCCC#N ; O=C(O)CCCCCCCCC(=O)O]

According to another embodiment, the reaction is performed in the presence of compounds of formulae (I′) and (II′) below:

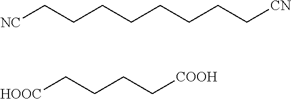 [SMILES: N#CCCCCCCCCC#N ; O=C(O)CCCCC(=O)O]

According to another embodiment, the reaction is performed in the presence of compounds of formulae (I′) and (II′) below:

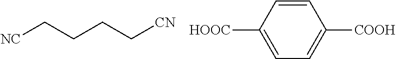 [SMILES: N#CCCCCC#N ; O=C(O)c1ccc(C(=O)O)cc1]

According to another embodiment, the reaction is performed in the presence of compounds of formulae (I′) and (II′) below:

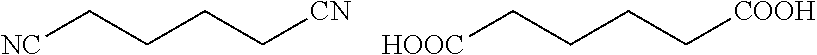 [SMILES: N#CCCCCC#N ; O=C(O)CCCCC(=O)O]

According to another embodiment, the reaction is performed in the presence of compounds of formulae (I′) and (II′) below:

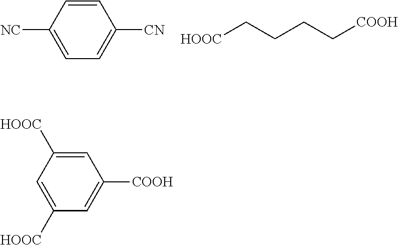 [SMILES: N#Cc1ccc(C#N)cc1 ; O=C(O)CCCCC(=O)O ; O=C(O)c1cc(C(=O)O)cc(C(=O)O)c1]

According to another embodiment, the reaction is performed in the presence of compounds of formulae (I′) and (II′) below:

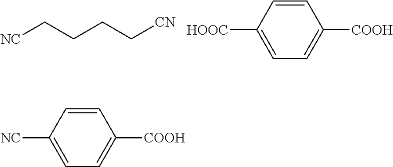 [SMILES: N#CCCCCC#N ; O=C(O)c1ccc(C(=O)O)cc1 ; N#Cc1ccc(C(=O)O)cc1]

According to one embodiment, the reaction is performed in the presence of a compound of formula (III′) below:

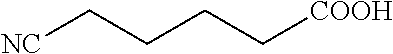

This compound corresponds to a compound of formula (III′) in which R′₃ represents —(CH₂)₄—.

The process according to the invention may advantageously lead to poly(N-acylamides) that are linear, branched or in the form of crosslinked networks, depending on the nature and/or the stoichiometric amount of the reagents used.

The process according to the invention may lead to poly(N-acylamides) that are branched or in the form of crosslinked networks, according to various parameters such as the number of functions present on the monomers, the type of functions present on the monomers, the stoichiometric ratio between the monomers, the stoichiometric ratio between the functions present on the monomers or the degree of progress of the reaction.

According to one embodiment, when the number of CN and/or CO₂H functions is greater than 2 in at least one of the compounds of formula (I), (II), (I′), (II′) or (III′), then the process leads to branched or crosslinked poly(N-acylamides). This embodiment corresponds especially to the case where one of the groups R₁, R₂, R′₁, R′₂ or R′₃ is substituted with a CN or CO₂H function.

According to one embodiment, when the number of CN and/or CO₂H functions is less than or equal to 2 in all the compounds of formula (I), (II), (I′), (II′) or (III′), then the process leads to linear poly(N-acylamides). This embodiment corresponds especially to the case where none of the groups R₁, R₂, R′₁, R′₂ or R′₃ is substituted with a CN or CO₂H function.

According to one embodiment, when the process is performed between a compound of formula (I′) in which R₁ is not substituted with a CO₂H group and a compound of formula (II′) in which R₂ is not substituted with a CN group, then a linear poly(N-acylamide) is obtained.

According to another embodiment, when a polyacid compound is used, corresponding especially to a compound of formula (I′) in which R₁ is especially substituted with a CO₂H group, the process according to the invention leads to a poly(N-acylamide) that is branched or in the form of a crosslinked network.

Similarly, when a polynitrile compound is used, corresponding especially to a compound of formula (II′) in which R₂ is especially substituted with a CN group, the process according to the invention leads to a poly(N-acylamide) that is branched or in the form of a crosslinked network.

According to the invention, the polycondensation reaction may be performed in solution, in solid bulk or in molten bulk. The reaction may also be performed in the presence of a liquid reagent.

In the context of the invention, and unless otherwise mentioned, the term “reaction performed in solution” means a reaction that is performed in the presence of a solvent.

In the context of the invention, and unless otherwise mentioned, the term “reaction performed in molten bulk” means a reaction that is performed in the absence of solvent, and in the presence of at least one reagent that has a melting point below the reaction temperature.

In the context of the invention, and unless otherwise mentioned, the term “reaction performed in solid bulk” means a reaction that is performed in the absence of solvent, and in the presence of reagents that have a melting point above the reaction temperature.

Typically, if the reaction is performed in solution, the solvent used must be compatible with the reaction conditions, and more particularly its boiling point (at the working pressure) must be greater than or equal to the reaction temperature, and the solvent must not be able to react with the reagents used. In particular, the solvent must not comprise any hydroxyl, amine, carboxylic acid or nitrile, etc. functions.

Preferably, the reaction is performed in molten bulk or in solid bulk.

The process according to the invention is advantageously performed at a temperature above the melting point of the monomer that has the lowest melting point.

Thus, the reaction may be performed either at a temperature above the melting point of at least one compound of formula (I) or at that of at least one compound of formula (II).

Preferably, the reaction is performed at a temperature from 150° C. to 300° C., preferentially from 180° C. to 300° C. In particular, the polycondensation reaction is performed at 270° C. or at a temperature from 180° C. to 200° C.

According to the invention, the reaction may be performed for several hours.

Preferably, the reaction is performed for 2 to 20 hours and preferentially for 3 to 14 hours.

In particular, the reaction is performed for 4 hours.

According to one embodiment, the reaction is heated for 7 hours at 180° C. and then for 7 hours at 200° C.

According to one embodiment, the reaction is heated for 4 hours at 270° C.

According to the invention, the reaction may be performed at atmospheric pressure.

According to the invention, the process may be performed in the presence of a catalyst. In particular, the process is performed in the presence of a catalyst chosen from orthophosphoric acid, ferric chloride, especially ferric chloride hexahydrate, aluminum chloride, phosphates, borophosphates, sulfuric acid, sulfonic acid, benzenesulfonic acids, toluenesulfonic acids such as para-toluenesulfonic acid, naphthalenesulfonic acids, silica, alumina, clay and silica/alumina. Preferably, the reaction is performed in the presence of orthophosphoric acid or ferric chloride hexahydrate.

The amount of catalyst used may be from 0.1 to 5 mol %, preferably between 0.5 mol % and 3 mol % and preferentially from 1 mol % to 2 mol %.

According to the invention, the reaction may be performed in a mole ratio r from 0.7/1 to 1/0.7, more preferentially from 0.9/1 to 1/0.9 between the acid CO₂H and nitrile CN functions (r=CO₂H/CN) of the starting compounds, especially of the compounds of formulae (I) and (II), irrespective of their distribution on the compounds. The mole ratio may vary according to the desired properties of the poly(N-acylamide). Typically, depending on the CO₂H/CN mole ratio used, the nature of the end functions of the poly(N-acylamide) obtained varies.

Preferably, the reaction is performed in a 1/1 mole ratio.

A subject of the present invention is also the poly(N-acylamides) as obtained via the abovementioned processes.

Thus, the present invention relates to poly(N-acylamides) of formula (P) below:

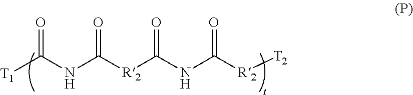

in which:

R′₁ and R′₂ are as defined previously, R′₁ possibly being identical or different, R′₂ possibly being identical or different,

t represents an integer from 1 to 1000, preferably from 1 to 200,

T₁ is chosen from the group consisting of:

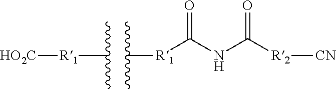

T₂ is chosen from the group consisting of:

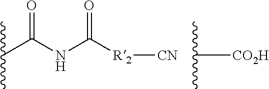

According to one embodiment, the present invention relates to the linear poly(N-acylamides) of formula (A) below:

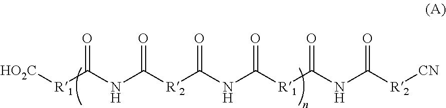

in which R′₁ and R′₂ are as defined previously, R′₁ possibly being identical or different, R′₂ possibly being identical or different, and n represents an integer from 1 to 1000 and preferably from 1 to 200.

The poly(N-acylamides) of formula (A) are poly(N-acylamides) of formula (P) in which:
t represents n,
T₁ represents:

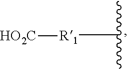

and
T₂ represents

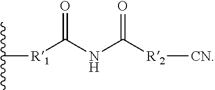

According to one embodiment, the poly(N-acylamides) of formula (P) or (A) are not those in which:

R′₁ represents

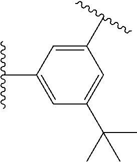 [SMILES: *c1cc(*)cc(C(C)(C)C)c1]

and R′₂ represents a group

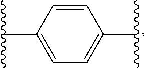 [SMILES: *c1ccc(*)cc1]

or vice versa,

R′₁ represents a butylene group and R′₂ represents a group

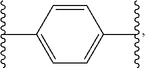 [SMILES: *c1ccc(*)cc1]

or vice versa,

R′₁ represents a group

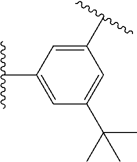 [SMILES: *c1cc(*)cc(C(C)(C)C)c1]

and R′₂ represents a group

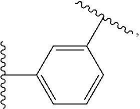 [SMILES: *c1cccc(*)c1]

or vice versa,

R′₁ represents a butylene group and R′₂ represents a group

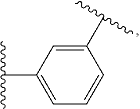 [SMILES: *c1cccc(*)c1]

or vice versa,

R′₁ represents an octylene group and R′₂ represents a group

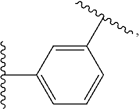 [SMILES: *c1cccc(*)c1]

or vice versa,

R′₁ represents a group

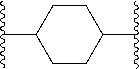 [SMILES: *C1CCC(*)CC1]

and R′₂ represents a group

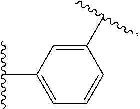 [SMILES: *c1cccc(*)c1]

or vice versa.

According to one embodiment, the poly(N-acylamides) of formula (P) or (A) are not those in which: R′₁ represents a group

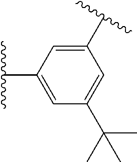 [SMILES: *c1cc(*)cc(C(C)(C)C)c1]

and R′₂ represents a group

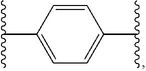 [SMILES: *c1ccc(*)cc1]

R′₁ represents a butylene group and R′₂ represents a group

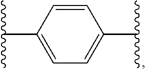 [SMILES: *c1ccc(*)cc1]

R′₁ represents a group

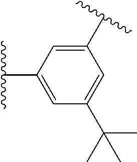 [SMILES: *c1cc(*)cc(C(C)(C)C)c1]

and R′₂ represents a group,

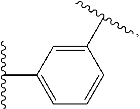 [SMILES: *c1cccc(*)c1]

R′₁ represents a butylene group and R′₂ represents a group

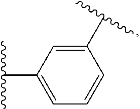 [SMILES: *c1cccc(*)c1]

R′₁ represents an octylene group and R′₂ represents a group

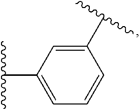 [SMILES: *c1cccc(*)c1]

R′₁ represents a group

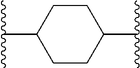 [SMILES: *C1CCC(*)CC1]

and R′₂ represents a group

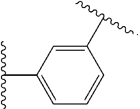 [SMILES: *c1cccc(*)c1]

According to another embodiment, the poly(N-acylamides) of formula (P) or (A) are not those in which: R′₁ represents a group

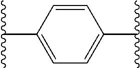 [SMILES: *c1ccc(*)cc1]

and R′₂ represents a group

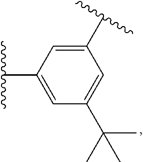 [SMILES: *c1cc(*)cc(C(C)(C)C)c1]

R′₁ represents a group

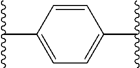 [SMILES: *c1ccc(*)cc1]

and R′₂ represents a butylene group,

R′₁ represents a group

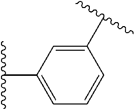 [SMILES: *c1cccc(*)c1]

and R′₂ represents a group

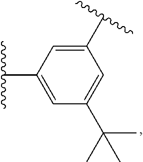 [SMILES: *c1cc(*)cc(C(C)(C)C)c1]

R′₁ represents a group

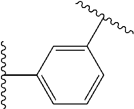 [SMILES: *c1cccc(*)c1]

and R′₂ represents a butylene group,

R′₁ represents a group

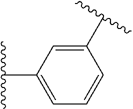 [SMILES: *c1cccc(*)c1]

and R′₂ represents an octylene group,

R′₁ represents a group

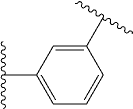 [SMILES: *c1cccc(*)c1]

and R′₂ represents a group

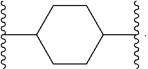 [SMILES: *C1CCC(*)CC1]

Among the poly(N-acylamides) of formula (P), mention may be made of those for which:
R′₁ represents

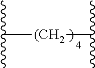

and R′₂ represents

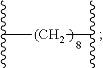

or
R′₁ represents

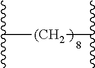

and R′₂ represents

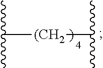

or
R′₁ represents

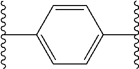 [SMILES: *c1ccc(*)cc1]

and R′₂ represents or

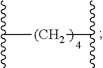

R′₁ represents

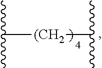

another R′₁ represents

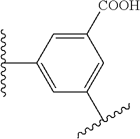 [SMILES: *c1cc(*)cc(C(=O)O)c1]

and R′₂ represents

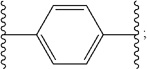 [SMILES: *c1ccc(*)cc1]

or
R′₁ represents

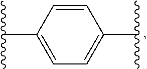 [SMILES: *c1ccc(*)cc1]

R′₂ represents

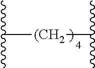

and another R′₂ represents,

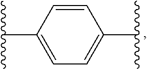

in which T₁ and T₂ are as defined previously.
Among the poly(N-acylamides) of formula (A), mention may be made of those for which:
R′₁ represents

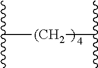

and R′₂ represents

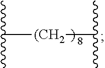

or
R′₁ represents

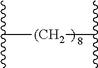

and R′₂ represents

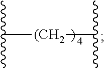

or
R′₁ represents

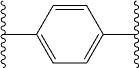 [SMILES: *c1ccc(*)cc1]

and R′₂ represents

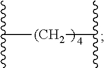

or
R′₁ represents

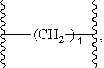

another R′₁ represents

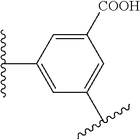 [SMILES: *c1cc(*)cc(C(=O)O)c1]

and R′₂ represents

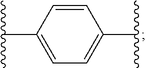 [SMILES: *c1ccc(*)cc1]

or
R′₁ represents

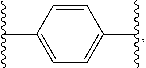 [SMILES: *c1ccc(*)cc1]

R′₂ represents

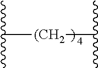

and another R′₂ represents

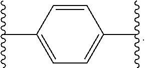 [SMILES: *c1ccc(*)cc1]

According to the invention, the poly(N-acylamides) of formula (A) comprise a repeating unit (unit repeated n times):

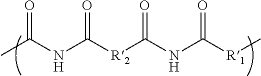

and the following end functions:

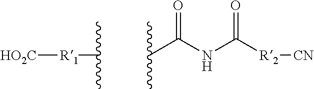

In the context of the invention, in the poly(N-acylamides) of formula (A), the group R′₁ in the repeating unit may be identical to or different from the group R′₁ in the end functions. Furthermore, in each repeating unit of the poly(N-acylamides) of formula (A), the group R′₁ may be of identical or different nature.

This may be explained especially by the use of a mixture of compounds of formula (I′) in which R′₁ is of different nature.

In the context of the invention, in the poly(N-acylamides) of formula (A), the group R′₂ in the repeating unit may be identical to or different from the group R′₂ in the end functions. Furthermore, in each repeating unit of the poly(N-acylamides) of formula (A), the group R′₂ may be of identical or different nature.

This may be explained especially by the use of a mixture of compounds of formula (II′) in which R′₂ is of different nature.

According to one embodiment, the present invention also relates to linear poly(N-acylamides) of formula (B) below:

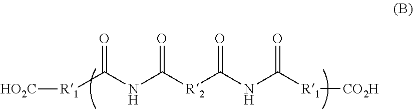

in which R′₁ and R′₂ are as defined previously, R′₁ possibly being identical or different, R′₂ possibly being identical or different, and m represents an integer from 1 to 1000 and preferably from 1 to 200.

The poly(N-acylamides) of formula (B) are poly(N-acylamides) of formula (P) in which:

t represents m,

T₁ represents:

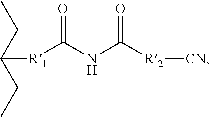

and

T₂ represents

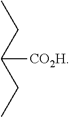

According to the invention, the poly(N-acylamides) of formula (B) comprise a repeating unit (unit repeated m times):

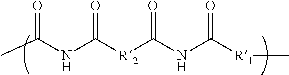

and the following end functions:

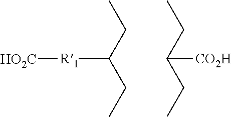

In the context of the invention, in the poly(N-acylamides) of formula (B), the group R′₁ in the repeating unit may be identical to or different from the group R′₁ in the end functions. Furthermore, in each repeating unit of the poly(N-acylamides) of formula (B), the group R′₁ may be of identical or different nature.

This may be explained especially by the use of a mixture of compounds of formula (I′) in which R′₁ is of different nature.

In the context of the invention, in the poly(N-acylamides) of formula (B), the group R′₂ in the repeating unit may be identical to or different from the group R′₂ in the end functions. Furthermore, in each repeating unit of the poly(N-acylamides) of formula (B), the group R′₂ may be of identical or different nature.

This may be explained especially by the use of a mixture of compounds of formula (II′) in which R′₂ is of different nature.

The present invention also relates to linear poly(N-acylamides) of formula (C) below:

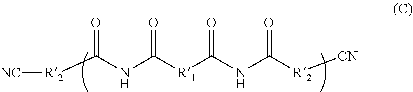

in which R′₁ and R′₂ are as defined previously, R′₁ possibly being identical or different, R′₂ possibly being identical or different, and p represents an integer from 1 to 1000 and preferably from 1 to 200.

The poly(N-acylamides) of formula (C) are poly(N-acylamides) of formula (P) in which:

t represents (p-1),

T₁ represents

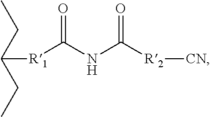

and

T₂ represents

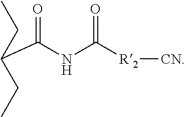

According to the invention, the poly(N-acylamides) of formula (C) comprise a repeating unit (unit repeated p times):

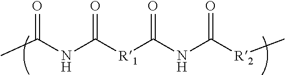

and the following end functions:

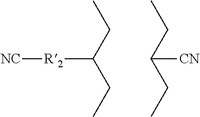

In the context of the invention, in the poly(N-acylamides) of formula (C), the group R′₁ in the repeating unit may be identical to or different from the group R′₁ in the end functions. Furthermore, in each repeating unit of the poly(N-acylamides) of formula (C), the group R′₁ may be of identical or different nature.

This may be explained especially by the use of a mixture of compounds of formula (I′) in which R′₁ is of different nature.

In the context of the invention, in the poly(N-acylamides) of formula (C), the group R′₂ in the repeating unit may be identical to or different from the group R′₂ in the end functions. Furthermore, in each repeating unit of the poly(N-acylamides) of formula (C), the group R′₂ may be of identical or different nature.

This may be explained especially by the use of a mixture of compounds of formula (II′) in which R′₂ is of different nature.

The present invention also relates to linear poly(N-acylamides) of formula (D) below:

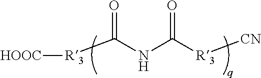

in which R′₃ is as defined previously, R′₃ possibly being identical or different, and q represents an integer from 1 to 1000 and preferably from 1 to 200.

According to the invention, the poly(N-acylamides) of formula (D) comprise a repeating unit (unit repeated q times):

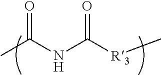

and the following end functions:

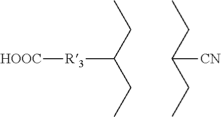

In the context of the invention, in the poly(N-acylamides) of formula (D), the group R′₃ in the repeating unit may be identical to or different from the group R′₃ in the end functions. Furthermore, in each repeating unit of the poly(N-acylamides) of formula (D), the group R′₃ may be of identical or different nature.

This may be explained especially by the use of a mixture of compounds of formula (III′) in which R′₃ is of different nature.

Another subject of the invention is the use of poly(N-acylamides) in the field of composites, extrusion, injection-molding or spinning.

The present invention also relates to compositions comprising at least one poly(N-acylamide) as described previously, or a mixture of poly(N-acylamides).

The compositions according to the invention may also comprise at least one additive chosen from arylamides, fibers, light stabilizers (especially UV stabilizers and/or heat stabilizers), plasticizers, dyes, mold-release agents, lubricants, fire retardants, usual fillers (such as talc, glass fiber, nanofillers, pigments, metal oxides, metals), impact modifiers, surfactants, optical brighteners, antioxidants and natural waxes, and mixtures thereof.

It has been shown that the process according to the invention advantageously makes it possible to prepare poly(N-acylamides) without the formation of side products. A process that is advantageously easy to perform, which does not necessarily require the use of solvent, has been developed. Moreover, the process according to the invention may advantageously be performed with a wide variety of starting reagents.

The examples that follow illustrate the invention without, however, limiting it.

### EXAMPLES

### Example 1

### Polycondensation of Adiponitrile and Sebacic Acid

1.74 g of adiponitrile (16 mmol), 3.26 g of sebacic acid (16 mmol) and about 25 mg of 85% orthophosphoric acid were placed in a glass tube. The reaction mixture was maintained for 4 hours at 270° C. in a heating mantle with magnetic stirring. The polymer (1) obtained is pasty at room temperature.

Differential thermal analysis shows a broad melting peak between 40° C. and 72° C.

Analysis by ¹³C nuclear magnetic resonance clearly shows the resonance peaks of the imide carbons in the region 174.0-174.5 ppm and those of the nitrile end groups at 120.5 ppm and carboxylic acid end groups at 173.8 ppm. The mean degree of polycondensation (DP) calculated on the basis of this indexation is 2.3 imides/chain, and the chain end distribution is 84 mol % of nitrile and 16 mol % of acid.

### Example 2

### Polycondensation of Sebaconitrile and Adipic Acid

According to the same procedure as in example 1, 2.65 g of sebaconitrile and 2.35 g of adipic acid were polycondensed in the presence of about 25 mg of orthophosphoric acid. The polymer (2) obtained is pasty at room temperature.

Differential thermal analysis shows a broad melting peak between 55° C. and 80° C. and a Tg at 46° C.

Analysis by ¹³C NMR indicates a mean DP of 1.8 imides/chain, and the chain end distribution is 85 mol % of nitrile and 15 mol % of acid.

### Example 3

### Polycondensation of Adiponitrile and Terephthalic Acid

According to the same procedure as in example 1, 1.97 g of adiponitrile (18 mmol) and 3.03 g of terephthalic acid (18 mmol) were polycondensed in the presence of about 25 mg of orthophosphoric acid, to give polymer (3).

Differential thermal analysis shows a melting peak at 212° C. and a Tg at 135° C.

### Example 4

### Polycondensation of Adiponitrile and Adipic Acid

According to the same procedure as in example 1, 2.13 g of adiponitrile (20 mmol) and 2.87 g of adipic acid (20 mmol) were polycondensed in the presence of about 25 mg of orthophosphoric acid. The polymer (4) obtained is solid at room temperature.

Differential thermal analysis shows a broad melting peak between 65° C. and 125° C. and a Tg at 57° C.

Analysis by ¹³C nuclear magnetic resonance clearly shows the resonance peaks of the imide carbons at 174.1 and 174.2 ppm and those of the nitrile end groups at 120.5 ppm and carboxylic acid end groups at 173.8 ppm. The mean degree of polycondensation calculated on the basis of this indexation is 5.0 imides/chain, and the chain end distribution is 72 mol % of nitrile and 28 mol % of acid.

### Example 5

### Polycondensation of Terephthalonitrile, Adipic Acid and Benzene-1,3,5-Tricarboxylic Acid

According to the same procedure as in example 1, 2.09 g of terephthalonitrile (16 mmol), 1.19 g of adipic acid (8 mmol) and 1.72 g of benzene-1,3,5-tricarboxylic acid (8 mmol) were polycondensed in the presence of about 25 mg of orthophosphoric acid. The polymer (5) obtained is solid at room temperature, insoluble and unmeltable (DSC), confirming the formation of a crosslinked network.

### Example 6

### Polycondensation of Terephthalic Acid, Adiponitrile and Terephthalonitrile

According to the same procedure as in example 1, 2.92 g of terephthalic acid (18 mmol), 0.95 g of adiponitrile (9 mmol) and 1.13 g of terephthalonitrile (9 mmol) were polycondensed in the presence of about 25 mg of orthophosphoric acid. The polymer (6) obtained is solid at room temperature.

Differential thermal analysis shows a glass transition temperature at about 190-220° C. but no melting peak up to 300° C., characteristic of an amorphous polymer.

### Example 7

### Polycondensation of Adiponitrile and Adipic Acid

According to the same procedure as in example 1, 2.15 g of adiponitrile (20 mmol) and 2.87 g of adipic acid (20 mmol) were polycondensed in the presence of about 25 mg of ferric chloride hexahydrate. The polymer (7) obtained is solid at room temperature.

Differential thermal analysis shows a broad melting peak between 60° C. and 150° C. ¹³C NMR analysis on the basis of the indexation of example 4 shows that the mean degree of polycondensation is 2.3 and the nitrile/acid chain end distribution is, respectively, 80 mol %/20 mol %.

### Example 8

### Polycondensation of 5-Cyanovaleric Acid

2.00 g of 5-cyanovaleric acid (16 mmol) and about 10 mg of orthophosphoric acid were placed in a glass tube. The reaction mixture was maintained for 7 hours at 180° C. and then for 7 hours at 200° C. in a heating mantle with magnetic stirring. The polymer (8) obtained is a pasty solid at room temperature.

¹³C NMR analysis on the basis of the indexation of example 4 shows that the mean degree of polycondensation is 4 and the nitrile/acid chain end distribution is, respectively, 85 mol %/15 mol %. Differential thermal analysis shows a broad melting peak between 50° C. and 90° C.

1. A process for preparing a poly(N-acylamide) by reaction between:
at least one compound of formula (I):
X—R₁—Y (I)
and
at least one compound of formula (II):
X′—R₂—Y′ (II)
in which:
R₁ and R₂ are, independently of each other, chosen from the group consisting of:
a linear or branched alkylene group comprising from 4 to 20 carbon atoms, optionally comprising heteroatoms, said alkylene group optionally being substituted;
an arylene group, comprising from 5 to 30 carbon atoms, said arylene group optionally being substituted;
a heteroarylene group comprising from 5 to 30 atoms, said heteroarylene group optionally being substituted;
a cycloalkylene group comprising from 5 to 30 carbon atoms, said cycloalkylene group optionally being substituted; and
an arylalkylene group comprising from 6 to 30 carbon atoms, said arylalkylene group optionally being substituted;
and
X, X′, Y and Y′ represent, independently of each other, a CN or CO₂H function, on condition that:
at least one from among X, X′, Y and Y′ represents a CN function;
at least one from among X, X′, Y and Y′ represents a CO₂H function;
when R₁ represents an arylene, heteroarylene or arylalkylene group, then X and Y are in the para or meta position relative to each other on, respectively, said arylene, heteroarylene or arylalkylene group, and
when R₂ represents an arylene, heteroarylene or arylalkylene group, then X′ and Y′ are in the para or meta position relative to each other on, respectively, said arylene, heteroarylene or arylalkylene group.

2. The process as claimed in claim 1, consisting of the reaction between:
at least one compound of formula (I),
at least one compound of formula (II), and
at least one compound of formula (IV):
R—Z (IV)
in which:
R represents:
an optionally substituted linear or branched alkyl group comprising from 1 to 20 carbon atoms;
an optionally substituted aryl group comprising from 6 to 30 carbon atoms;
an optionally substituted heteroaryl group comprising from 5 to 30 atoms;
an optionally substituted arylalkyl group comprising from 6 to 30 carbon atoms; and
Z represents COOH or CN.

3. The process as claimed in claim 1, consisting of the reaction between:
at least one compound of formula (I′):
HOOC—R′₁—COOH (I′)
and
at least one compound of formula (II′):
NC—R′₂—CN (II′)
in which:
R′₁ and R′₂ are, independently of each other, chosen from the group consisting of:
a linear or branched alkylene group comprising from 4 to 20 carbon atoms, optionally comprising heteroatoms, said alkylene group optionally being substituted;
an arylene group, comprising from 5 to 30 carbon atoms, said arylene group optionally being substituted;
a heteroarylene group comprising from 5 to 30 atoms, said heteroarylene group optionally being substituted;
a cycloalkylene group comprising from 5 to 30 carbon atoms, said cycloalkylene group optionally being substituted; and
an arylalkylene group comprising from 6 to 30 carbon atoms, said arylalkylene group optionally being substituted.

4. The process as claimed in claim 43, consisting of the reaction between:
at least one compound of formula (III′):
NC—R′₃—COOH (III′)
and
at least one identical or different compound of formula (III′), or
at least one compound of formula (I′); or
at least one compound of formula (II′),
wherein R′₃ is selected from the group consisting of:
a linear or branched alkylene group comprising from 4 to 20 carbon atoms, optionally comprising heteroatoms, said alkylene group optionally being substituted;
an optionally substituted arylene group comprising from 5 to 30 carbon atoms;
an optionally substituted heteroarylene group comprising from 5 to 30 atoms; and
an optionally substituted cycloalkylene group comprising from 5 to 30 carbon atoms;
an optionally substituted arylalkylene group comprising from 6 to 30 carbon atoms;
on condition that when R′₃ represents an arylene, heteroarylene or arylalkylene, the nitrile function and the acid function are in the meta or para position relative to each other on, respectively, said arylene, heteroarylene or arylalkylene group.

5. The process as claimed in claim 1, consisting of the reaction between:
at least one compound of formula (III′):
NC—R′₃—COOH (III′),
and
at least one compound of formula (I′):
HOOC—R′₁—COOH (I′),
and
at least one compound of formula (II′):
NC—R′₂—CN (II′).
wherein:
R′₁ and R′₂ are, independently of each other, chosen from the group consisting of:
a linear or branched alkylene group comprising from 4 to 20 carbon atoms, optionally comprising heteroatoms, said alkylene group optionally being substituted;
an arylene group, comprising from 5 to 30 carbon atoms, said arylene group optionally being substituted;
a heteroarylene group comprising from 5 to 30 atoms, said heteroarylene group optionally being substituted;
a cycloalkylene group comprising from 5 to 30 carbon atoms, said cycloalkylene group optionally being substituted; and
an arylalkylene group comprising from 6 to 30 carbon atoms, said arylalkylene group optionally being substituted, and
R′₃ is selected from the group consisting of:
a linear or branched alkylene group comprising from 4 to 20 carbon atoms, optionally comprising heteroatoms, said alkylene group optionally being substituted;
an optionally substituted arylene group comprising from 5 to 30 carbon atoms;
an optionally substituted heteroarylene group comprising from 5 to 30 atoms; and
an optionally substituted cycloalkylene group comprising from 5 to 30 carbon atoms;
an optionally substituted arylalkylene group comprising from 6 to 30 carbon atoms;
on condition that when R′₃ represents an arylene, heteroarylene or arylalkylene, the nitrile function and the acid function are in the meta or para position relative to each other on, respectively, said arylene, heteroarylene or arylalkylene group.

6. The process as claimed in claim 1, wherein the reaction is performed in solution, in solid bulk or in molten bulk.

7. The process as claimed in claim 1, in which the reaction is performed at a temperature above the melting point of the compound of formula (I) or (II) that has the lowest melting point.

8. The process as claimed in claim 7, in which the reaction is performed at a temperature from 150° C. to 300° C.

9. The process as claimed in claim 1, in which the reaction is performed at atmospheric pressure.

10. The process as claimed in claim 1, in which the reaction is performed in the presence of a catalyst, chosen especially from orthophosphoric acid, ferric chloride, especially ferric chloride hexahydrate, aluminum chloride, phosphates, borophosphates, sulfuric acid, sulfonic acid, benzenesulfonic acids, toluenesulfonic acids such as para-toluenesulfonic acid, naphthalenesulfonic acids, silica, alumina, clay and silica/alumina.

11. The process as claimed in claim 10, in which the catalyst is chosen from orthophosphoric acid and ferric chloride hexahydrate.

12. The process as claimed in claim 3, in which compound (I′) is one of the following compounds:

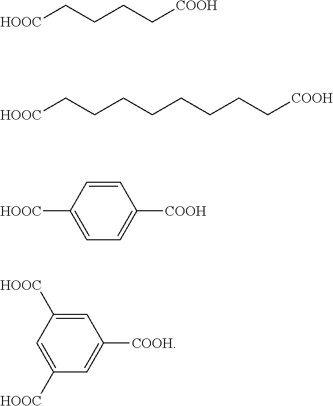 [SMILES: O=C(O)CCCCC(=O)O ; O=C(O)CCCCCCCCC(=O)O ; O=C(O)c1ccc(C(=O)O)cc1 ; O=C(O)c1cc(C(=O)O)cc(C(=O)O)c1]

13. The process as claimed in claim 3, in which compound (II′) is one of the following compounds:

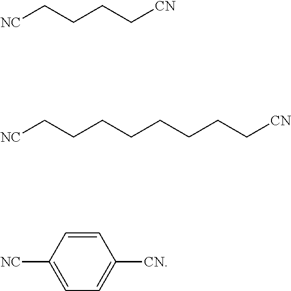 [SMILES: N#CCCCCC#N ; N#CCCCCCCCCC#N ; N#Cc1ccc(C#N)cc1]

14. The process as claimed in claim 4, in which compound (III′) is one of the following compounds:

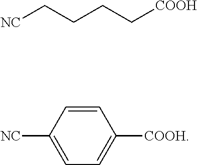 [SMILES: N#CCCCCC(=O)O ; N#Cc1ccc(C(=O)O)cc1]

15. A poly(N-acylamide) of formula (P): 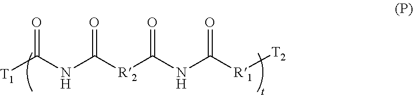
in which:
R′₁ and R′₂ are, independently of each other, chosen from the group consisting of:
a linear or branched alkylene group comprising from 4 to 20 carbon atoms, optionally comprising heteroatoms, said alkylene group optionally being substituted;
an arylene group, comprising from 5 to 30 carbon atoms, said arylene group optionally being substituted;
a heteroarylene group comprising from 5 to 30 atoms, said heteroarylene group optionally being substituted;
a cycloalkylene group comprising from 5 to 30 carbon atoms, said cycloalkylene group optionally being substituted; and
an arylalkylene group comprising from 6 to 30 carbon atoms, said arylalkylene group optionally being substituted, with each R′₁ possibly being identical or different, and each R′₂ possibly being identical or different,
t represents an integer from 1 to 1000, preferably from 1 to 200,
T₁ is chosen from the group consisting of: 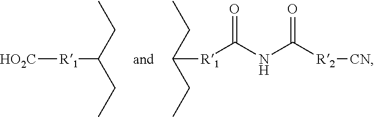
and
T₂ is chosen from the group consisting of:

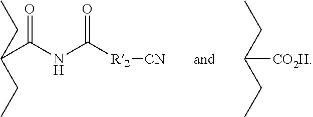

16. The poly(N-acylamide) as claimed in claim 15, in which:
R′₁ represents 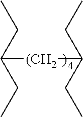
and R′₂ represents 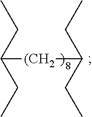
or
R′₁ represents 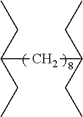
and R′₂ represents 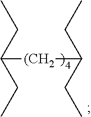
or
R′₁ represents 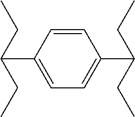 [SMILES: CCC(CC)c1ccc(C(CC)CC)cc1]
and R′₂ represents 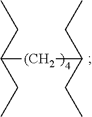
or
R′₁ represents 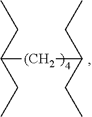
another R′₁ represents 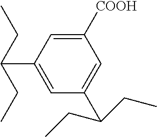 [SMILES: CCC(CC)c1cc(C(=O)O)cc(C(CC)CC)c1]
and R′₂ represents 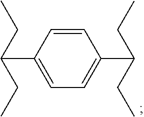 [SMILES: CCC(CC)c1ccc(C(CC)CC)cc1]
or
R′₁ represents 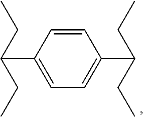 [SMILES: CCC(CC)c1ccc(C(CC)CC)cc1]
R′₂ represents 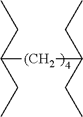
and another R′₂ represents 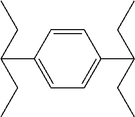 [SMILES: CCC(CC)c1ccc(C(CC)CC)cc1]
